(19) United States
(12) Patent Application Publication
(10) Pub. No.: US 2020/0118705 A1
(43) Pub. Date: Apr. 16, 2020

(54) INSULATED ELECTRIC WIRE

(71) Applicants: SUMITOMO ELECTRIC INDUSTRIES, LTD., Osaka-shi, Osaka (JP); SUMITOMO ELECTIC WINTEC, INC., Koka-shi, Shiga (JP)

(72) Inventors: Shuhei MAEDA, Osaka-shi (JP); Masaaki YAMAUCHI, Osaka-shi (JP); Tokiko UMEMOTO, Osaka-shi (JP); Yasushi TAMURA, Koka-shi (JP)

(73) Assignees: SUMITOMO ELECTRIC INDUSTRIES, LTD., Osaka-shi, Osaka (JP); SUMITOMO ELECTRIC WINTEC, INC., Koka-shi, Shiga (JP)

(21) Appl. No.: 16/617,258

(22) PCT Filed: Jun. 15, 2018
(86) PCT No.: PCT/JP2018/022921

§ 371 Date: Nov. 26, 2019

(30) Foreign Application Priority Data
Jun. 15, 2017 (JP) 2017-117609
Jun. 15, 2017 (JP) 2017-117610

(51) Int. Cl. H01B 3/30; C09D 179/08; C08G 73/10

(52) U.S. Cl. CPC H01B 3/306; C08G 73/1071; C09D 179/08

(57) ABSTRACT

An insulated electric wire includes a conductor that has a linear shape and an insulating film that is formed to cover the periphery of the conductor. The insulating film is formed of a polyimide that has a molecular structure including a PMDA-ODA-type repeating unit A and a BPDA-ODA-type repeating unit B, the mole ratio [B/(A+B)]×100 (% by mole) of the number of moles of the repeating unit B to the total number of moles of the repeating unit A and the repeating unit B being more than 55% by mole. A first sample of the insulating film with a separation elongation of 7% has a ratio M₆₀/M₁₀ of 1.2 or more, or a second sample of the insulating film with a separation elongation of 40% has a ratio M₃₀/M₁₀ of 1.2 or more.

### TECHNICAL FIELD

The present disclosure relates to an insulated electric wire. The present application claims the priority of Japanese Patent Application No. 2017-117609, filed Jun. 15, 2017 and Japanese Patent Application No. 2017-117610, filed Jun. 15, 2017, which are incorporated herein by reference in their entirety.

### BACKGROUND ART

Patent Literature 1 discloses an insulated electric wire that has high heat resistance, has high crazing resistance, and is less likely to cause corona discharge.

### CITATION LIST

### Patent Literature

PTL 1: Japanese Unexamined Patent Application Publication No. 2013-253124

### SUMMARY OF INVENTION

### Solution to Problem

An insulated electric wire according to a first aspect of the present disclosure includes a conductor that has a linear shape and an insulating film formed to cover the periphery of the conductor. The insulating film is formed of a polyimide that has a molecular structure including a repeating unit A represented by the following general formula (1) and

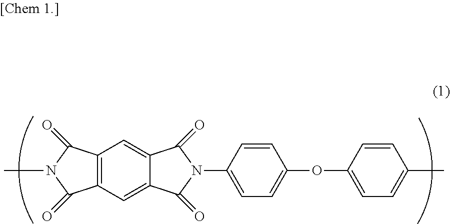

a repeating unit B represented by the following general formula (2),

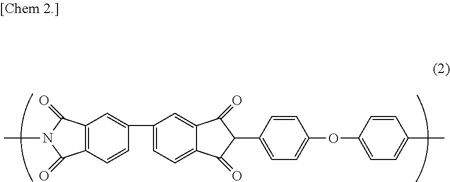

the mole ratio [B/(A+B)]×100 (% by mole) of the number of moles of the repeating unit B to the total number of moles of the repeating unit A and the repeating unit B being more than 55% by mole.

In a tensile test performed at a crosshead speed of 10 mm/min on a first sample of the insulating film with a separation elongation of 7%, the ratio M₆₀/M₁₀ of tensile stress M₆₀ at an elongation percentage of 60% to tensile stress M₁₀ at an elongation percentage of 10% is 1.2 or more.

An insulated electric wire according to a second aspect of the present disclosure includes a conductor that has a linear shape and an insulating film formed to cover the periphery of the conductor. The insulating film is formed of a polyimide that has a molecular structure including a repeating unit A represented by the following general formula (1) and

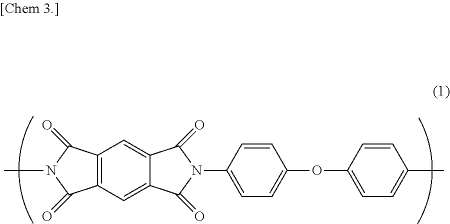

a repeating unit B represented by the following general formula (2),

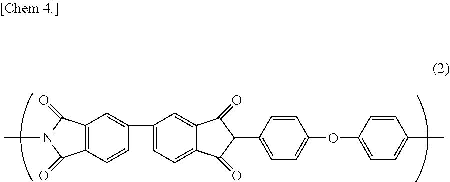

the mole ratio [B/(A+B)]×100 (% by mole) of the number of moles of the repeating unit B to the total number of moles of the repeating unit A and the repeating unit B being more than 55% by mole.

In a tensile test performed at 10 mm/min on a second sample of the insulating film with a separation elongation of 40%, the ratio M₃₀/M₁₀ of tensile stress M₃₀ at an elongation percentage of 30% to tensile stress M₁₀ at an elongation percentage of 10% is 1.2 or more.

### BRIEF DESCRIPTION OF DRAWINGS

FIG. 1 is a schematic cross-sectional view of an insulated electric wire.

FIG. 2 is a schematic graph of a stress-strain curve of an insulating film in a tensile test of a first sample.

FIG. 3 is a schematic graph of a stress-strain curve of an insulating film in a tensile test of a second sample.

FIG. 4 is a flow chart of the steps in a process of producing an insulated electric wire.

FIG. 5 is a schematic cross-sectional view of an insulated electric wire.

FIG. 6 is an X-ray profile of an insulating film.

FIG. 7 is a flow chart of the steps in a process of producing an insulated electric wire.

FIG. 8 is a scattered X-ray profile and a diffraction pattern profile of an insulating film according to Example 2-1.

FIG. 9 is a scattered X-ray profile and a diffraction pattern profile of an insulating film according to Example 2-2.

FIG. 10 is a scattered X-ray profile and a diffraction pattern profile of an insulating film according to Example 2-3.

FIG. 11 is a scattered X-ray profile and a diffraction pattern profile of an insulating film according to Comparative Example 2-1.

FIG. 12 is a scattered X-ray profile and a diffraction pattern profile of an insulating film according to Comparative Example 2-2.

FIG. 13 is a scattered X-ray profile and a diffraction pattern profile of an insulating film according to Comparative Example 2-3.

FIG. 14 is a scattered X-ray profile and a diffraction pattern profile of an insulating film according to Comparative Example 2-4.

FIG. 15 is a scattered X-ray profile and a diffraction pattern profile of an insulating film according to Comparative Example 2-5.

### DESCRIPTION OF EMBODIMENTS

### Problems to be Solved by Present Disclosure

Polyimide is used as good insulating materials in insulating films of insulated electric wires. With an increase in applications of electrical and electronic components, however, insulated electric wires are increasingly used in severer environments than before. Accordingly, insulating films are required to have higher durability than existing insulated electric wires. For example, there is a demand for an insulated electric wire including an insulating film with less degradation even when exposed to a severe environment, such as a high temperature and high humidity environment, for extended periods (with high resistance to hygrothermal degradation).

Accordingly, one object is to provide an insulated electric wire including an insulating film with high resistance to hygrothermal degradation.

### Advantageous Effects of Present Disclosure

An insulated electric wire including an insulating film with high resistance to hygrothermal degradation can be provided.

### DESCRIPTION OF EMBODIMENTS OF PRESENT DISCLOSURE

First, the embodiments of the present disclosure are described below. An insulated electric wire according to a first embodiment of the present disclosure includes a conductor that has a linear shape and an insulating film formed to cover the periphery of the conductor. The insulating film is formed of a polyimide that has a molecular structure including a repeating unit A represented by the formula (1) and a repeating unit B represented by the formula (2), the mole ratio [B/(A+B)]×100 (% by mole) of the number of moles of the repeating unit B to the total number of moles of the repeating unit A and the repeating unit B being more than 55% by mole. In a tensile test performed at a crosshead speed of 10 mm/min on a first sample of the insulating film with a separation elongation of 7%, the ratio M₆₀/M₁₀ of tensile stress M₆₀ at an elongation percentage of 60% to tensile stress M₁₀ at an elongation percentage of 10% is 1.2 or more.

An insulated electric wire according to a second embodiment of the present disclosure includes a conductor that has a linear shape and an insulating film formed to cover the periphery of the conductor. The insulating film is formed of a polyimide that has a molecular structure including a repeating unit A represented by the formula (1) and a repeating unit B represented by the formula (2), the mole ratio [B/(A+B)]×100 (% by mole) of the number of moles of the repeating unit B to the total number of moles of the repeating unit A and the repeating unit B being more than 55% by mole. In a tensile test performed at 10 mm/min on a second sample of the insulating film with a separation elongation of 40%, the ratio M₃₀/M₁₀ of tensile stress M₃₀ at an elongation percentage of 30% to tensile stress M₁₀ at an elongation percentage of 10% is 1.2 or more.

The most widely used polyimide is a PMDA-ODA-type polyimide composed of pyromellitic dianhydride (PMDA) and 4,4′-diaminodiphenyl ether (4,4′-oxydianiline (ODA)). The PMDA-ODA-type polyimide has a molecular structure composed only of a PMDA-ODA-type repeating unit A represented by the formula (1). The PMDA-ODA-type polyimide is a material with high heat resistance and insulating properties. Thus, the PMDA-ODA-type polyimide is applied to an insulating film of an insulated electric wire.

With an increase in applications of electrical and electronic components, however, insulated electric wires are increasingly used in severer environments than before. Accordingly, there is a demand for an insulated electric wire including an insulating film with higher durability than existing insulated electric wires. For example, insulated electric wires are also used in a severe environment, such as in a high temperature and high humidity environment. In such a case, some imide groups may be hydrolyzed when exposed to a high temperature and high humidity environment for extended periods. A severe, high temperature and high humidity environment may significantly decrease the molecular weight, cause a crack, and impair the function of the insulating layer. Thus, there is a demand for an insulated electric wire including an insulating film with less degradation even when exposed to a high temperature and high humidity environment for extended periods (with high resistance to hygrothermal degradation).

A polyimide constituting an insulating film of an insulated electric wire according to the present disclosure contains, together with the repeating unit A, a predetermined proportion of a BPDA-ODA-type repeating unit B composed of a 3,3′,4,4′-biphenyltetracarboxylic dianhydride (BPDA) and ODA as a constitutional unit of the polyimide. The investigation of the present inventors showed that such a polyimide suffers less degradation than a PMDA-ODA-type polyimide composed only of the repeating unit A even when exposed to a high temperature and high humidity environment for extended periods. More specifically, the hydrolysis resistance of a polyimide insulating film in a high temperature and high humidity environment is improved when the mole ratio [B/(A+B)]×100 (% by mole) of the number of moles of the repeating unit B to the total number of moles of the repeating unit A and the repeating unit B in the polyimide is more than 55% by mole.

The investigation of the present inventors showed that only an improvement of hydrolysis resistance by the BPDA-ODA-type repeating unit B is insufficient to more sufficiently reduce fissures or cracks. More specifically, it was found that in a tensile test performed at a crosshead speed of 10 mm/min on a first sample of an insulating film with a separation elongation of 7%, if the ratio M₆₀/M₁₀ of tensile stress M₆₀ at an elongation percentage of 60% to tensile stress M₁₀ at an elongation percentage of 10% is less than 1.2, exposure to a high temperature and high humidity environment for extended periods is likely to cause a crack even when the mole ratio [B/(A+B)]×100 (% by mole) is more than 55% by mole.

It was also found that in a tensile test performed at 10 mm/min on a second sample of an insulating film with a separation elongation of 40%, if the ratio M₃₀/M₁₀ of tensile stress M₃₀ at an elongation percentage of 30% to tensile stress M₁₀ at an elongation percentage of 10% is less than 1.2, exposure to a high temperature and high humidity environment for extended periods is likely to cause a crack even when the mole ratio [B/(A+B)]×100 (% by mole) is more than 55% by mole.

This is probably due to the following reason, for example. In a tensile test of an insulating film, the insulating film is initially elongated in an elastic deformation dominant state and is then elongated in a plastic deformation dominant state in a high elongation percentage region. The ratio M₆₀/M₁₀ of less than 1.2 in the first sample or the ratio M₃₀/M₁₀ of less than 1.2 in the second sample means that the stress does not increase significantly in the plastic deformation dominant region. This is probably due to easy intermolecular sliding within the polyimide during plastic deformation. In such an easy intermolecular sliding state, even slight hydrolysis causes intermolecular sliding in the hydrolyzed portion and tends to cause a crack. Thus, a polyimide with a ratio M₆₀/M₁₀ of less than 1.2 in the first sample or with a ratio M₃₀/M₁₀ of less than 1.2 in the second sample is likely to have a fissure or crack when exposed to a high temperature and high humidity environment for extended periods.

On the other hand, a polyimide with a ratio M₆₀/M₁₀ of 1.2 or more in the first sample or with a ratio M₃₀/M₁₀ of 1.2 or more in the second sample is less likely to have intermolecular sliding in a high elongation percentage region and is less likely to have a fissure or crack. Thus, it was found that it is important to specify the constitutional unit ratio of a polyimide and to maintain at least a certain ratio of stress at a higher elongation percentage to stress at a lower elongation percentage to ensure high durability in a high temperature and high humidity environment. Thus, an insulating film with a mole ratio represented by [B/(A+B)]×100 (% by mole) of more than 55% by mole and with a ratio M₆₀/M₁₀ of 1.2 or more in the first sample or a ratio M₃₀/M₁₀ of 1.2 or more in the second sample can be used to provide an insulated electric wire including a polyimide insulating film with fewer defects.

In the insulated electric wire, the mole ratio of a polyimide represented by [B/(A+B)]×100 (% by mole) is preferably less than 80% by mole. This facilitates the preparation of a polyimide with a ratio M₆₀/M₁₀ of 1.2 or more or with a ratio M₃₀/M₁₀ of 1.2 or more.

An insulated electric wire according to a third embodiment of the present disclosure includes a linear conductor and an insulating film disposed to cover the periphery of the conductor. The insulating film is formed of a polyimide that has a molecular structure including a repeating unit A represented by the formula (1) and a repeating unit B represented by the formula (2), the ratio of the amount of the repeating unit B to the total amount of the repeating unit A and the repeating unit B being 60% or more by mole. In a scattered X-ray profile of the insulating film analyzed by X-ray diffractometry at a diffraction angle 20 of 10 degrees or more and 41 degrees or less, the ratio of the area of a second region between a diffraction pattern profile extracted from the scattered X-ray profile and a base line to the area of a first region between the scattered X-ray profile and the base line (hereinafter also referred to as the “molecular regularity peak ratio”) is 15% or less. The ratio of the amount of the repeating unit B to the total amount of the repeating unit A and the repeating unit B is represented by {(B)/[(A)+(B)]}×100 (% by mole), wherein (A) denotes the number of moles of the repeating unit A, and (B) denotes the number of moles of the repeating unit B.

The most widely used polyimide is a PMDA-ODA-type polyimide composed of pyromellitic dianhydride (PMDA) and 4,4′-diaminodiphenyl ether (4,4′-oxydianiline (ODA)). The PMDA-ODA-type polyimide has a molecular structure composed only of a PMDA-ODA-type repeating unit A represented by the formula (1). The PMDA-ODA-type polyimide is a material with high heat resistance and insulating properties. Thus, the PMDA-ODA-type polyimide is applied to an insulating film of an insulated electric wire.

With an increase in applications of electrical and electronic components, however, insulated electric wires are increasingly used in severer environments than before. Accordingly, there is a demand for an insulated electric wire including an insulating film with higher durability than existing insulated electric wires. For example, insulated electric wires are also used in a severe environment, such as in a high temperature and high humidity environment. In such a case, some imide groups may be hydrolyzed when exposed to a high temperature and high humidity environment for extended periods. A severe, high temperature and high humidity environment may significantly decrease the molecular weight, cause a crack, and impair the function of the insulating layer. Thus, there is a demand for an insulated electric wire including an insulating film with less degradation even when exposed to a high temperature and high humidity environment for extended periods (with high resistance to hygrothermal degradation).

The polyimide constituting the insulating film of the insulated electric wire according to the third embodiment of the present disclosure contains, together with the repeating unit A, a predetermined proportion of a BPDA-ODA-type repeating unit B composed of a 3,3′,4,4′-biphenyltetracarboxylic dianhydride (BPDA) and ODA as a constitutional unit of the polyimide. The investigation of the present inventors showed that such a polyimide suffers less degradation than a PMDA-ODA-type polyimide composed only of the repeating unit A even when exposed to a high temperature and high humidity environment for extended periods. More specifically, the hydrolysis resistance of the polyimide insulating film in a high temperature and high humidity environment is improved when the ratio of the amount of the repeating unit B to the total amount of the repeating unit A and the repeating unit B in the polyimide is 60% or more by mole.

The investigation of the present inventors showed that only an improvement of hydrolysis resistance by the BPDA-ODA-type repeating unit B is insufficient to more sufficiently reduce fissures or cracks. More specifically, it was found that when the molecular regularity peak ratio is more than 15%, exposure to a high temperature and high humidity environment for extended periods is likely to cause a crack even when the amount of the repeating unit B is 60% or more by mole.

This is probably because when a stress is applied to polyimide molecules, one BPDA-ODA-type block (repeating unit B) can slide easily on another BPDA-ODA-type block between the molecules. In such an easy intermolecular sliding state, if a degradation point is formed by hydrolysis, a crack starting from the degradation point can easily develop. However, the investigation of the present inventors showed that when the molecular regularity peak ratio is 15% or less, even exposure to a high temperature and high humidity environment for extended periods is less likely to cause or develop a crack.

The molecular regularity peak ratio represents the regularity of the molecular arrangement of an insulating film formed of a polyimide. Higher regularity of the molecular arrangement probably results in fewer molecular entanglements and more sliding. By contrast, a molecular regularity peak ratio of 15% or less probably results in sufficiently low regularity of the molecular arrangement, more molecular entanglements, and limited intermolecular sliding. Consequently, an insulated electric wire including a polyimide insulating film with high resistance to a high temperature and high humidity environment can be provided.

In the insulated electric wire, the ratio of the amount of the repeating unit B to the total amount of the repeating unit A and the repeating unit B is preferably less than 80% by mole. This facilitates the formation of an insulating film of a polyimide with a molecular regularity peak ratio of 15% or less.

### Details of Embodiments of Present Disclosure

Embodiments of an insulated electric wire according to the present disclosure and a method for producing the insulated electric wire are described below with reference to the accompanying drawings. In the drawings, identical or corresponding portions are denoted by the same reference numerals and will not be described again.

### First Embodiment

### [Structure of Insulated Electric Wire]

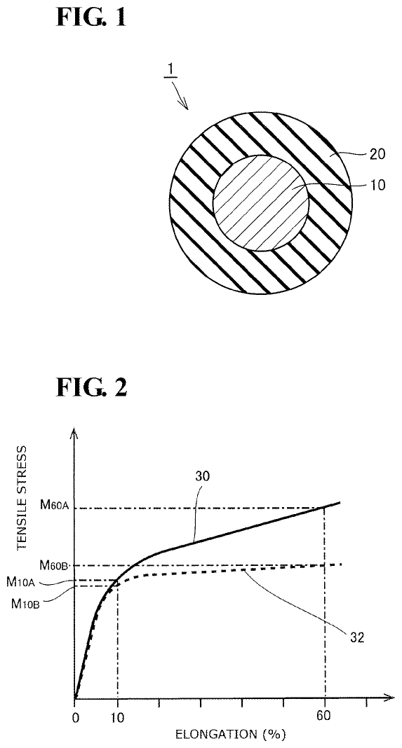

First, an insulated electric wire 1 according to the present embodiment is described below. FIG. 1 is a schematic cross-sectional view of an insulated electric wire. In FIG. 1, the insulated electric wire 1 according to the present embodiment includes a conductor 10 that has a linear shape and an insulating film 20 formed to cover the periphery of the conductor 10.

For example, the conductor 10 is preferably formed of a metal with high electric conductivity and high mechanical strength. Examples of such a metal include copper, copper alloys, aluminum, aluminum alloys, nickel, silver, soft iron, steel, and stainless steel. The conductor 10 of the insulated electric wire may be formed of a linearly formed material of one of these metals or a multilayer structure produced by covering such a linear material with another metal, for example, a nickel-coated copper wire, a silver-coated copper wire, a copper-coated aluminum wire, or a copper-coated steel wire.

The conductor 10 may have any diameter depending on the use. Although the conductor 10 and the insulated electric wire 1 have a circular cross-sectional shape in FIG. 1, the conductor 10 and the insulated electric wire 1 may have any cross-sectional shape, provided that the conductor 10 is linear. For example, with respect to a cross section perpendicular to the longitudinal direction, the conductor 10 with a rectangular or polygonal cross-sectional shape may substitute for the linear conductor 10 with a circular cross-sectional shape.

The insulating film 20 is formed to cover the periphery of the conductor 10. For example, the insulating film 20 is layered on the periphery of the conductor 10. The insulating film 20 may be composed of a single insulating layer or a plurality of insulating layers. In the insulated electric wire 1 composed of a plurality of insulating layers, each insulating layer is successively layered from the center of a cross section of the conductor 10 to the periphery. In this case, each insulating layer can have an average thickness of 1 μm or more and 5 μm or less, for example. The plurality of insulating layers can have an average total thickness of 10 μm or more and 200 μm or less, for example. The total number of the plurality of insulating layers can be 2 or more and 200 or less, for example.

The single insulating layer or each of the plurality of insulating layers constituting the insulating film 20 is formed of a polyimide having a molecular structure containing the repeating unit A represented by the formula (1) and the repeating unit B represented by the formula (2). In the molecular structure, the mole ratio [B/(A+B)]×100 (% by mole) of the number of moles of the repeating unit B to the total number of moles of the repeating unit A and the repeating unit B is more than 55% by mole. When the mole ratio [B/(A+B)]×100 (% by mole) is more than 55% by mole, the insulating film 20 can have high hydrolysis resistance when exposed to a high temperature and high humidity environment for extended periods.

Hydrolysis of the polyimide is partly responsible for a fissure or crack in the insulating film 20. The repeating unit B content is preferably increased to improve the hydrolysis resistance of the polyimide. The hydrolysis resistance of the polyimide can be improved to increase the resistance to hygrothermal degradation. Thus, a high repeating unit B content can result in the insulated electric wire 1 with high resistance to hygrothermal degradation. More specifically, the mole ratio [B/(A+B)]×100 (% by mole) of the number of moles of the repeating unit B to the total number of moles of the repeating unit A and the repeating unit B in the polyimide should be more than 55% by mole.

The mole ratio [B/(A+B)]×100 (% by mole) is preferably more than 60% by mole. A mole ratio [B/(A+B)]×100 (% by mole) of more than 60% by mole can result in the insulated electric wire 1 with higher resistance to hygrothermal degradation. The mole ratio [B/(A+B)]×100 (% by mole) is preferably less than 80% by mole. At a mole ratio [B/(A+B)]×100 (% by mole) of less than 80% by mole, it is easy to prepare a polyimide with a ratio M₆₀/M₁₀ of 1.2 or more in the first sample or with a ratio M₃₀/M₁₀ of 1.2 or more in the second sample, as described below.

In the insulated electric wire 1, in a tensile test performed at a crosshead speed of 10 mm/min on the first sample of the insulating film 20 with a separation elongation of 7%, the ratio M₆₀/M₁₀ of tensile stress M₆₀ at an elongation percentage of 60% to tensile stress M₁₀ at an elongation percentage of 10% is 1.2 or more.

In the insulated electric wire 1, in a tensile test performed at 10 mm/min on the second sample of the insulating film 20 with a separation elongation of 40%, the ratio M₃₀/M₁₀ of tensile stress M₃₀ at an elongation percentage of 30% to tensile stress M₁₀ at an elongation percentage of 10% is 1.2 or more.

The term “separation elongation”, as used herein, refers to the elongation (%) of the insulated electric wire 1 when a tensile test sample of the insulating film 20 is prepared from the insulated electric wire 1. It is not easy to directly separate the conductor 10 from the insulating film 20 in the insulated electric wire 1. To prepare a tensile test sample (a first sample or a second sample) of the insulating film 20 from the insulated electric wire 1, the insulated electric wire 1 including both the conductor 10 and the insulating film 20 is elongated to a predetermined length, for example, with a tensile tester to facilitate the separation of the conductor 10 from the insulating film 20. Subsequently, for example, the conductor 10 is subjected to electrolysis (for example, electrolysis in saline) to form a gap between the conductor 10 and the insulating film 20, separate the conductor 10 from the insulating film 20, and thereby isolate the insulating film 20. The isolated insulating film 20 is used as the first sample or the second sample in the tensile test. Although not particularly limited, for example, the electrolysis in saline can be performed under the following conditions: saline concentration: 5%, electrode: positive electrode=carbon electrode, negative electrode=the conductor 10, voltage=20 V.

Elongation with a tensile tester or the like to facilitate the separation of the conductor 10 from the insulating film 20 is referred to as separation elongation. The phrase “a separation elongation of 7%”, as used herein, means elongation of the insulated electric wire 1 to 107% of the original length in this preliminary separation. The phrase “a separation elongation of 40%”, as used herein, means elongation of the insulated electric wire 1 to 140% of the original length in this preliminary separation.

The first sample or the second sample to be prepared from the insulating film 20 can be appropriately selected according to the state of the insulated electric wire 1 or the like. For example, if the separation of the conductor 10 from the insulating film 20 in the insulated electric wire 1 is relatively easy, the insulating film 20 can be separated from the conductor 10 at a separation elongation of 7%, and the first sample can be prepared as a tensile test sample. If sufficient pretreatment is required to promote the separation of the conductor 10 from the insulating film 20, the insulating film 20 is separated from the conductor 10 at a separation elongation of 40%, and the second sample can be prepared as a tensile test sample. Both the first sample and the second sample may be prepared from the same insulated electric wire 1.

In general, a smaller interface area between the conductor 10 and the insulating film 20 tends to result in relatively easier separation of the insulating film 20. A smaller area of a cross section of the conductor 10 perpendicular to the longitudinal direction results in a smaller interface area. Thus, for example, for a round wire (the insulated electric wire 1 in which the conductor 10 has a circular cross section perpendicular to the longitudinal direction), both the first sample and the second sample tend to be easily prepared from a wire with a small wire diameter.

The interface area also depends on the size of the conductor 10 and the shape of the conductor 10. For example, for a round wire in which the conductor 10 has a circular cross section perpendicular to the longitudinal direction, a larger wire diameter of the conductor 10 tends to result in greater difficulty in preparing the first sample. Thus, for the insulated electric wire 1 in which the conductor 10 has a relatively large cross-sectional area, the second sample is prepared for the evaluation in the tensile test. A comparison between a round wire and a rectangular wire (the insulated electric wire 1 in which the conductor 10 has a tetragonal cross section perpendicular to the longitudinal direction) in which the diameter of a circular cross section is the same as the length of a side of a square cross section shows that the conductor 10 in the round wire has a smaller lateral area. The lateral area corresponds to the interface area between the conductor 10 and the insulating film 20. Thus, in a comparison between a round wire and a rectangular wire of the same size, both the first sample and the second sample tend to be more easily prepared from the round wire. Preparing and testing the second sample tend to be more often appropriate in rectangular wires than in round wires.

The relationship between the tensile stress M₁₀, the tensile stress M₆₀, and the ratio M₆₀/M₁₀ in a tensile test performed at a crosshead speed of 10 mm/min on the first sample of the insulating film 20 with a separation elongation of 7% is described below with reference to FIG. 2. FIG. 2 is a schematic graph of a stress-strain curve of the insulating film 20 in a tensile test of the first sample. A stress-strain curve 30 corresponds to a ratio M₆₀/M₁₀ of 1.6. M₁₀ denotes tensile stress at an elongation percentage of 10%, and M₆₀ denotes tensile stress at an elongation percentage of 60%. A stress-strain curve 32 corresponds to a ratio M₆₀/M₁₀ of 1.18. In the stress-strain curve 30, which corresponds to a ratio M₆₀/M₁₀ of 1.2 or more, the slope is large at an elongation percentage of more than 10%. By contrast, in the stress-strain curve 32, which corresponds to a ratio M₆₀/M₁₀ of less than 1.2, the slope is small at an elongation percentage of more than 10%.

The stress-strain curve 30 (solid line) in FIG. 2 shows that the insulated electric wire 1 including the insulating film 20 with a ratio M₆₀/M₁₀ of 1.2 or more is less likely to have a defect, such as a fissure or crack, even when exposed to a high temperature and high humidity environment for extended periods. By contrast, the stress-strain curve 32 (dotted line) shows that the insulated electric wire 1 including the insulating film 20 with a ratio M₆₀/M₁₀ of less than 1.2 is likely to have a defect, such as a fissure or crack, when exposed to a high temperature and high humidity environment for extended periods.

This is probably due to the following reason, for example. In FIG. 2, when the insulating film 20 formed of a polyimide is elongated, the insulating film 20 is initially elongated in an elastic deformation dominant state and is then elongated in a plastic deformation dominant state. For a polyimide, elastic deformation dominates at an elongation percentage of approximately 10% or less, and plastic deformation dominates at an elongation percentage of more than 10%. Thus, plastic deformation dominates at an elongation percentage of 60%. In plastic deformation, molecules slide on each other and move in the tensile direction, and stress in the plastic deformation depends on intermolecular force or the number of molecule entanglements. Thus, a lower ratio M₆₀/M₁₀ results in weaker intermolecular force or fewer molecule entanglements, and molecules are more likely to slide continuously on each other. Thus, a crack is easily developed.

A higher repeating unit B content results in higher molecular rigidity, fewer molecular entanglements, and a lower ratio M₆₀/M₁₀. Satisfying the condition of a ratio M₆₀/M₁₀ of 1.2 or more in the first sample of the insulating film 20 can provide the insulated electric wire 1 with fewer defects.

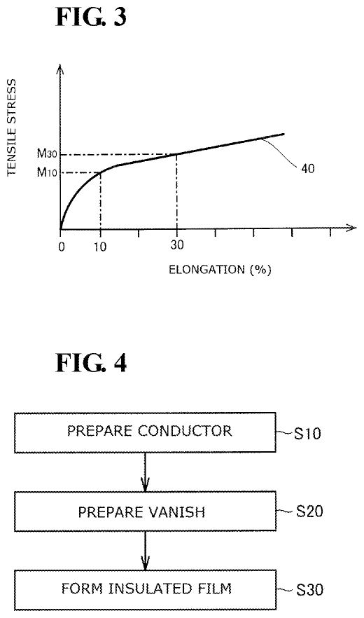

Next, the relationship between the tensile stress M₁₀, the tensile stress M₃₀, and the ratio M₃₀/M₁₀ in a tensile test performed at a crosshead speed of 10 mm/min on the second sample of the insulating film 20 with a separation elongation of 40% is described below with reference to FIG. 3. FIG. 3 is a schematic graph of a stress-strain curve of the insulating film 20 in a tensile test of the second sample. A stress-strain curve 40 corresponds to a ratio M₃₀/M₁₀ of 1.3. M₁₀ denotes tensile stress at an elongation percentage of 10%, and M₃₀ denotes tensile stress at an elongation percentage of 30%.

The insulating film 20 has some permanent strain in the second sample with a separation elongation of 40% compared with the first sample with a separation elongation of 7% at the point in time when the insulating film 20 is separated from the conductor 10.

The ratio M₃₀/M₁₀ in the second sample indicates the degree of increase in tensile stress in the plastic deformation dominant state. As described above, in plastic deformation, molecules slide on each other and move in the tensile direction, and stress in the plastic deformation depends on intermolecular force or the number of molecule entanglements. Thus, a lower ratio M₃₀/M₁₀ in the second sample results in weaker intermolecular force or fewer molecule entanglements, and molecules are more likely to slide continuously on each other. Thus, a crack is easily developed. Thus, in the same manner as for the ratio M₆₀/M₁₀ in the first sample, satisfying the condition of a ratio M₃₀/M₁₀ of 1.2 or more in the second sample of the insulating film 20 can provide the insulated electric wire 1 with fewer defects.

As described above, on the basis of the relationship between hydrolysis resistance and intermolecular sliding in plastic deformation, the insulating film 20 should satisfy the condition (1): the insulating film 20 is formed of a polyimide in which the mole ratio [B/(A+B)]×100 (% by mole) of the number of moles of the repeating unit B to the total number of moles of the repeating unit A and the repeating unit B is more than 55% by mole.

Furthermore, the insulating film 20 should satisfy at least one of the following conditions (2) and (3).

(2) In a tensile test performed at a crosshead speed of 10 mm/min on the first sample of the insulating film 20 with a separation elongation of 7%, the ratio M₆₀/M₁₀ of tensile stress M₆₀ at an elongation percentage of 60% to tensile stress M₁₀ at an elongation percentage of 10% is 1.2 or more.

(3) In a tensile test performed at 10 mm/min on the second sample of the insulating film 20 with a separation elongation of 40%, the ratio M₃₀/M₁₀ of tensile stress M₃₀ at an elongation percentage of 30% to tensile stress M₁₀ at an elongation percentage of 10% is 1.2 or more.

The insulating film 20 only needs to satisfy the condition (1) and at least one of the conditions (2) and (3). The insulating film 20 may satisfy the condition (1) and both the condition (2) and the condition (3). For example, the first sample with a separation elongation of 7% and the second sample with a separation elongation of 40% prepared from the same insulated electric wire 1 may satisfy both conditions for the ratio M₆₀/M₁₀ and the ratio M₃₀/M₁₀. For example, if it is difficult to separate the insulating film 20 from the conductor 10 at a separation elongation of 7%, or if the first sample cannot have sufficient elongation to calculate the ratio M₆₀/M₁₀, preliminary separation may be performed at a separation elongation of 40% to separate the insulating film 20 from the conductor 10, and the resulting second sample may have a ratio M₃₀/M₁₀ of 1.2 or more.

The ratio M₆₀/M₁₀ in the first sample and the ratio M₃₀/M₁₀ in the second sample depend on not only the composition (repeating unit ratio) of the polyimide but also the molecular weight and the synthesis conditions for varnish. Thus, it is impossible to determine the ratio M₆₀/M₁₀ or the ratio M₃₀/M₁₀ from the mole ratio [B/(A+B)]×100 (% by mole) alone. However, at a mole ratio [B/(A+B)]×100 (% by mole) of more than 55% by mole and less than 80% by mole, it is easy to control the preparation of the insulating film 20 formed of a polyimide with a ratio M₆₀/M₁₀ of 1.2 or more in the first sample or with a ratio M₃₀/M₁₀ of 1.2 or more in the second sample. Thus, to prepare a polyimide with a ratio M₆₀/M₁₀ of 1.2 or more in the first sample or with a ratio M₃₀/M₁₀ of 1.2 or more in the second sample, the mole ratio [B/(A+B)]×100 (% by mole) is preferably more than 55% by mole and less than 80% by mole, and the mole ratio [B/(A+B)]×100 (% by mole) is preferably more than 60% by mole and less than 80% by mole.

### [Other Layers]

The insulated electric wire 1 according to the present embodiment may further include layers other than the insulating film 20. For example, a resin covering layer formed of another resin may be disposed between the conductor 10 and the insulating film 20, that is, radially inside the insulating film 20. Examples of the resin covering layer include a PMDA-ODA polyimide layer composed of PMDA- and ODA-derived repeating units, a polyimide layer including a repeating unit derived from a tetracarboxylic dianhydride component other than PMDA and BPDA, and a polyimide layer including a repeating unit derived from a diamine component other than ODA. Examples of the resin covering layer other than polyimide include a covering layer formed of another insulating resin, such as a polyamideimide layer or a polyetherimide layer. When these layers are disposed radially inside the insulating film 20, the hydrolysis resistance of the whole insulated electric wire 1 is maintained by the protective effect of the insulating film 20. Thus, even if the resin covering layer has lower hydrolysis resistance than the insulating film 20, the resistance to hygrothermal degradation of the whole insulated electric wire 1 is sufficiently maintained.

Examples of the tetracarboxylic dianhydride component other than PMDA and BPDA include 3,3′,4,4′-benzophenonetetracarboxylic dianhydride (BTDA), 4,4′-oxydiphthalic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, 1,1-bis(3,4-dicarboxyphenyl)ethane dianhydride, 1,1-bis(2,3-dicarboxyl)enyl)ethane dianhydride, bis(3,4-dicarboxyphenyl)methane dianhydride, bis(2,3-dicarboxyphenyl)methane dianhydride, bis(3,4-dicarboxyphenyl)sulfone dianhydride, bis(3,4-dicarboxyphenyl)ether dianhydride, 1,2,5,6-naphthalene tetracarboxylic dianhydride, and 2,3,6,7-naphthalene tetracarboxylic dianhydride. Dimethyl-4,4′-diaminodiphenylmethane, 3,3′,5,5′-tetramethyl-4,4′-diaminodiphenylmethane, and the like are listed.

Examples of the diamine component other than ODA include diaminodiphenyl ethers (ODAs), such as 4,4′-diaminodiphenyl ether (4,4′-ODA), 3,4′-diaminodiphenyl ether (3,4′-ODA), 3,3′-diaminodiphenyl ether (3,3′-ODA), 2,4′-diaminodiphenyl ether (2,4′-ODA), and 2,2′-diaminodiphenyl ether (2,2′-ODA), 2,2-bis[4-(4-aminophenoxy)phenyl]propane (BAPP), 4,4′-bis(4-aminophenoxy)biphenyl (BAPB), 4,4′-diaminodiphenylmethane, 3,4′-diaminodiphenylmethane, 3,3′-diaminodiphenylmethane, 2,4′-diaminodiphenylmethane, 2,2′-diaminodiphenylmethane, 4,4′-diaminodiphenyl sulfone, 3,4′-diaminodiphenyl sulfone, 3,3′-diaminodiphenyl sulfone, 2,4′-diaminodiphenyl sulfone, 2,2′-diaminodiphenyl sulfone, 4,4′-diaminodiphenyl sulfide, 3,4′-diaminodiphenyl sulfide, 3,3′-diaminodiphenyl sulfide, 2,4′-diaminodiphenyl sulfide, 2,2′-diaminodiphenyl sulfide, para-phenylenediamine (PPD), meta-phenylenediamine, p-xylylenediamine, m-xylylenediamine, 2,2′-dimethyl-4,4′-diaminobiphenyl, 1,5-diaminonaphthalene, 4,4′-benzophenonediamine, 3,3 ‘-dimethyl-4,4’-diaminodiphenylmethane, and 3,3′,5,5′-tetramethyl-4,4′-diaminodiphenylmethane.

The insulated electric wire 1 according to the present embodiment may further include a coating layer radially outside the insulating film 20. Examples of the coating layer include a surface lubricating layer.

### [Production of Insulated Electric Wire]

Next, the steps in a method for producing the insulated electric wire 1 according to the present embodiment are described below with reference to FIGS. 1 and 4. FIG. 4 is a flow chart of the steps in a process of producing the insulated electric wire 1. In the present embodiment, the steps S10 to S30 illustrated in FIG. 4 are performed.

### [Preparation of Conductor 10]

As illustrated in FIGS. 1 and 4, the linear conductor 10 is prepared (S10). More specifically, a unit wire is prepared, and the unit wire is subjected to processing, such as drawing (wire drawing), to prepare the conductor 10 with a desired diameter and shape. The unit wire is preferably formed of a metal with high electric conductivity and high mechanical strength. Examples of such a metal include copper, copper alloys, aluminum, aluminum alloys, nickel, silver, soft iron, steel, and stainless steel. The conductor 10 of the insulated electric wire 1 may be formed of a linearly formed material of one of these metals or a multilayer structure produced by covering such a linear material with another metal, for example, a nickel-coated copper wire, a silver-coated copper wire, a copper-coated aluminum wire, or a copper-coated steel wire.

The average cross-sectional area of the conductor 10 of the insulated electric wire 1 preferably has a lower limit of 0.01 mm², more preferably 0.1 mm². The average cross-sectional area of the conductor 10 preferably has an upper limit of 15 mm², more preferably 10 mm². When the conductor 10 has an average cross-sectional area smaller than the lower limit, the resistance may increase. On the other hand, when the conductor 10 has an average cross-sectional area larger than the upper limit, bending of the insulated electric wire 1 may be difficult.

[Preparation of Varnish (Poly(amic acid) Solution)]

Next, a varnish containing a polyimide precursor poly(amic acid) (poly(amic acid) solution) is prepared (S20).

### (Polyimide Precursor)

A polyimide precursor, which is a raw material of the polyimide, is a polymer that forms the polyimide by imidization, and is a reaction product produced by polymerization between tetracarboxylic dianhydride PMDA and BPDA and a diamine ODA. Thus, the raw materials of the polyimide precursor are PMDA, BPDA, and ODA.

### (Tetracarboxylic Dianhydride)

Tetracarboxylic dianhydride used as raw materials of the polyimide precursor are pyromellitic dianhydride (PMDA) and 3,3′,4,4′-biphenyltetracarboxylic dianhydride (BPDA). The mole ratio of the number of moles of BPDA to the total number of moles of PMDA and BPDA is more than 55% by mole. Preferably, the mole ratio is more than 60% by mole. The mole ratio preferably has an upper limit of 95% by mole, more preferably 92% by mole. At a BPDA content in the above range, a BPDA-derived structure can be appropriately introduced into the main component polyimide of the insulating layer. Consequently, the appearance, bending workability, and resistance to hygrothermal degradation can be improved in a balanced manner.

The lower limit of the PMDA content per 100% by mole of the tetracarboxylic dianhydride used as raw materials of the polyimide precursor is preferably 5% by mole, more preferably 8% by mole. The upper limit of the PMDA content is preferably 45% by mole, more preferably 20% by mole. A PMDA content lower than the lower limit may result in insufficient heat resistance of the insulating layer. On the other hand, a PMDA content higher than the upper limit may result in insufficient introduction of a BPDA-derived structure into the main component polyimide of the insulating layer and may result in lower resistance to hygrothermal degradation of the insulating layer.

### (Diamine)

A diamine used as a raw material of the polyimide precursor is 4,4′-diaminodiphenyl ether (4,4′-oxydianiline (ODA)). ODA can be used to improve the tenacity of the insulating layer.

### (Molecular Weight of Polyimide Precursor)

The weight-average molecular weight of the polyimide precursor preferably has a lower limit of 10,000, more preferably 15,000. The weight-average molecular weight preferably has an upper limit of 180,000, more preferably 130,000. The polyimide precursor with a weight-average molecular weight greater than or equal to the lower limit can form an extensible polyimide that can easily retain a constant molecular weight even after hydrolysis, and thereby can further improve the flexibility and resistance to hygrothermal degradation of the insulating layer. The polyimide precursor with a weight-average molecular weight smaller than or equal to the upper limit can suppress an extreme increase in the viscosity of a resin varnish for use in the production of the insulated electric wire and improve coating performance. Furthermore, the concentration of the polyimide precursor in the resin varnish can be easily increased while good coating performance is maintained. The term “weight-average molecular weight”, as used herein, refers to the value measured by gel permeation chromatography (GPC) according to JIS-K7252-1: 2008 “Plastics—Determination of average molecular mass and molecular mass distribution of polymers using size-exclusion chromatography—Part 1: General principles”.

### (Preparation of Varnish Containing Polyimide Precursor)

The polyimide precursor can be produced by a polymerization reaction between the tetracarboxylic dianhydride(s) and the diamine. The polymerization reaction can be performed by a known method for synthesizing a polyimide precursor. In the present embodiment, first, 100% by mole of the diamine ODA is dissolved in N-methyl-2-pyrrolidone (NMP). 95% by mole to 100% by mole of tetracarboxylic dianhydride composed of PMDA and BPDA at a predetermined ratio are then added and stirred in a nitrogen atmosphere. The reaction is then performed at 80° C. for 3 hours while stirring. After the reaction, the reaction solution is naturally cooled to room temperature. Thus, a varnish containing the polyimide precursor dissolved in N-methyl-2-pyrrolidone is prepared.

Although N-methyl-2-pyrrolidone (NMP) is used as an organic solvent in the embodiment, another aprotic polar organic solvent may also be used. Examples of the other aprotic polar organic solvent include N,N-dimethylformamide, N,N-dimethylacetamide, dimethyl sulfoxide, and γ-butyrolactone. These organic solvents may be used alone or in combination. The term “aprotic polar organic solvent”, as used herein, refers to a polar organic solvent that has no proton-release group.

Any amount of the organic solvent may be used, provided that PMDA, BPDA, and ODA can be uniformly dispersed. For example, the amount of the organic solvent to be used may be 100 parts or more by mass and 1,000 parts or less by mass per 100 parts by mass of PMDA, BPDA, and ODA in total.

The polymerization reaction conditions may be appropriately determined depending on the raw materials to be used or the like. For example, the reaction temperature may be 10° C. or more and 100° C. or less, and the reaction time may be 0.5 hours or more and 24 hours or less.

The mole ratio (tetracarboxylic dianhydride/diamine) of the tetracarboxylic dianhydride (PMDA and BPDA) to the diamine (ODA) used in the polymerization is preferably closer to 100/100 in order to efficiently promote the polymerization reaction. For example, the mole ratio may be 95/105 or more and 105/95 or less.

The varnish may contain another component or additive agent in addition to the above components within the bounds of not reducing the above effects. For example, the varnish may contain various additive agents, such as a pigment, a dye, an inorganic or organic filler, a curing accelerator, a lubricant, an adhesion improver, and a stabilizer, and another compound, such as a reactive low-molecular-weight compound.

An insulating film that satisfies at least one of the two conditions: the ratio M₆₀/M₁₀ of tensile stress M₆₀ at an elongation percentage of 60% to tensile stress M₁₀ at an elongation percentage of 10% is 1.2 or more in the tensile test performed at a crosshead speed of 10 mm/min on the first sample of the insulating film with a separation elongation of 7%, and the ratio M₆₀/M₁₀ of tensile stress M₆₀ at an elongation percentage of 60% to tensile stress M₁₀ at an elongation percentage of 10% is 1.2 or more in the tensile test performed at a crosshead speed of 10 mm/min on the first sample of the insulating film with a separation elongation of 7%, can be prepared by adjusting the blend ratio of the raw materials PMDA, BPDA, and ODA for the polyimide or by adjusting the molecular weight of poly(amic acid) or the baking conditions. The ratio M₄₀/M₁₀ can be adjusted by changing the polymerization conditions, the temperature conditions, and the addition method.

### [Formation of Insulating Film 20]

The conductor 10 is then covered with the insulating film 20 (S30). The insulating film 20 is formed to cover the periphery of the conductor 10 that has a linear shape. First, the varnish prepared in S20 is applied to the surface of the conductor 10 to form a coating film on the surface of the conductor 10. The conductor 10 on which the coating film is formed is passed through a furnace heated to, for example, 350° C. to 500° C. for 20 seconds to 2 minutes, for example, for 30 seconds, for heating. Heating the coating film promotes imidization by dehydration of poly(amic acid), hardens the coating film, and forms the insulating film 20 of the polyimide on the conductor 10. The coating and heating cycle is performed, for example, 10 times to increase the thickness of the insulating film 20. Consequently, the insulating film 20 can have a desired thickness (for example, 35 μm). In this manner, the insulated electric wire 1 is produced that includes the conductor 10 and the insulating film 20 of the polyimide formed to cover the periphery of the conductor 10.

### Second Embodiment

### [Structure of Insulated Electric Wire]

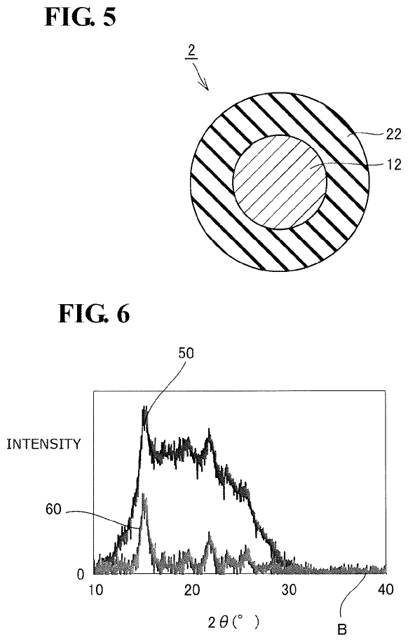

Next, an insulated electric wire according to another embodiment is described below. FIG. 5 is a schematic cross-sectional view of the insulated electric wire. In FIG. 5, an insulated electric wire 2 according to the present embodiment includes a linear conductor 12 and an insulating film 22 disposed to cover the periphery of the conductor 12.

For example, the conductor 12 is preferably formed of a metal with high electric conductivity and high mechanical strength. Examples of such a metal include copper, copper alloys, aluminum, aluminum alloys, nickel, silver, soft iron, steel, and stainless steel. The conductor 12 of the insulated electric wire may be formed of a linearly formed material of one of these metals or a multilayer structure produced by covering such a linear material with another metal, for example, a nickel-coated copper wire, a silver-coated copper wire, a copper-coated aluminum wire, or a copper-coated steel wire.

The conductor 12 may have any diameter depending on the use. Although the conductor 12 and the insulated electric wire 2 have a circular cross-sectional shape in FIG. 5, the conductor 12 and the insulated electric wire 2 may have any cross-sectional shape, provided that the conductor 12 is linear. For example, with respect to a cross section perpendicular to the longitudinal direction, the conductor 12 with a rectangular or polygonal cross-sectional shape may substitute for the linear conductor 12 with a circular cross-sectional shape.

The insulating film 22 is formed to cover the periphery of the conductor 12. For example, the insulating film 22 is layered on the periphery of the conductor 12. The insulating film 22 may be composed of a single insulating layer or a plurality of insulating layers. In the insulated electric wire 2 composed of a plurality of insulating layers, each insulating layer is successively layered from the center of a cross section of the conductor 12 to the periphery. In this case, each insulating layer can have an average thickness of 1 μm or more and 5 μm or less, for example. The plurality of insulating layers can have an average total thickness of 10 μm or more and 200 μm or less, for example. The total number of the plurality of insulating layers can be 2 or more and 200 or less, for example.

The single insulating layer or each of the plurality of insulating layers constituting the insulating film 22 is formed of a polyimide having a molecular structure containing the repeating unit A represented by the formula (1) and the repeating unit B represented by the formula (2). The ratio of the amount of the repeating unit B to the total amount of the repeating unit A and the repeating unit B is 60% or more by mole.

Hydrolysis of the polyimide is partly responsible for a fissure or crack in the insulating film 22. The repeating unit B content is preferably increased to improve the hydrolysis resistance of the polyimide. The hydrolysis resistance of the polyimide can be improved to increase the resistance to hygrothermal degradation. Thus, a high repeating unit B content can result in the insulated electric wire 2 including the insulating film 22 with high resistance to hygrothermal degradation. In particular, the ratio of the amount of the repeating unit B to the total amount of the repeating unit A and the repeating unit B should be 60% or more by mole to ensure sufficient resistance to hygrothermal degradation.

The ratio of the amount of the repeating unit B to the total amount of the repeating unit A and the repeating unit B is preferably 62% or more by mole, preferably less than 80% by mole, more preferably 78% by mole. When the ratio is less than 80% by mole, this facilitates the formation of a polyimide insulating film with a molecular regularity peak ratio of 15% or less.

Referring to FIG. 6, the feature “In a scattered X-ray profile of the insulating film 20 analyzed by X-ray diffractometry at a diffraction angle 20 of 10 degrees or more and 41 degrees or less, the ratio of the area of a second region between a diffraction pattern profile extracted from the scattered X-ray profile and a base line to the area of a first region between the scattered X-ray profile and the base line (the molecular regularity peak ratio) is 15% or less.” is described below. FIG. 6 is an X-ray profile of the insulating film 22.

X rays applied to the insulating film 22 formed of the polyimide are scattered by the polyimide in the insulating film 22 (scattered X-rays). A scattered X-ray profile is obtained by receiving the scattered X-rays with a detector and recording the intensity of the received scattered X-rays. When the polyimide is regularly arranged, scattered X-rays interfere with one another at a particular diffraction angle (an angle between the incident direction of the incident X-ray and the propagation direction of the scattered X-rays) 2θ and generate strong diffracted X-rays. The strong diffracted X-rays appear as a sharp peak in the scattered X-ray profile. On the other hand, low regularity of the polyimide results in a broad peak in the scattered X-ray profile.

A scattered X-ray profile 50 as shown in FIG. 6 is obtained by analyzing the structure of the insulating film 22 formed of the polyimide by X-ray diffractometry and subtracting the background from the resulting profile data using software. For example, the software is, but not limited to, X'Pert HighScore Plus available from PANalytical. More specifically, the scattered X-ray profile 50 is obtained using this software under the following data processing conditions: background assignment=automatic, granularity=100, pending factor=0, use of data after smoothing=none.

A diffraction pattern profile 60 is obtained, for example, using the software under the following data processing conditions: background assignment=automatic, granularity=5, pending factor=0, use of data after smoothing=none, and by subtracting the background and halo pattern. The diffraction pattern profile 60 is a profile in which only peaks corresponding to peaks derived from a structure with high regularity of molecular arrangement are extracted from the scattered X-ray profile 50.

Next, a method for determining the “molecular regularity peak ratio” (in a scattered X-ray profile of the insulating film 22 analyzed by X-ray diffractometry at a diffraction angle 2θ of 10 degrees or more and 41 degrees or less, the ratio of the area of a second region between a diffraction pattern profile extracted from the scattered X-ray profile and a base line to the area of a first region between the scattered X-ray profile and the base line) is described below with reference to FIG. 6.

To determine the molecular regularity peak ratio, in the scattered X-ray profile in FIG. 6, first, the area of a first region between the scattered X-ray profile 50 and a base line B (hereinafter referred to as a first area) is determined at a diffraction angle 2θ of 10 degrees or more and 41 degrees or less. Next, the area of a second region between the diffraction pattern profile 60 corresponding to peaks derived from a structure with high regularity of molecular arrangement and the base line B (hereinafter referred to as a second area) is determined at a diffraction angle 2θ of 10 degrees or more and 41 degrees or less. Although not particularly limited, the first area and the second area are determined, for example, by converting profile data obtained by the above method to a comma-separated values (CSV) file, extracting the intensity at each diffraction angle 2θ (0.03 degree intervals), and totaling the intensities at a diffraction angle 2θ in the range of 10.025 degrees to 40.985 degrees. If the intensity is negative, not 0 but the negative value is added. The molecular regularity peak ratio can then be calculated using the formula [(second area)/(first area)]×100.

Probably, a higher molecular regularity peak ratio results in weaker intermolecular force or fewer molecule entanglements, and molecules are more likely to slide continuously on each other. Thus, exposure of the insulating film 22 to a high temperature and high humidity environment for extended periods is likely to cause a crack. In the present embodiment, the molecular regularity peak ratio is 15% or less. In this case, the insulated electric wire 2 can include the insulating film 22 that is less likely to cause a crack even when exposed to a high temperature and high humidity environment for extended periods.

Thus, the insulating film 22 of the insulated electric wire 2 according to the present embodiment satisfies the following two conditions. First, on the basis of the relationship between hydrolysis resistance and intermolecular sliding in plastic deformation, the condition (1): the insulating film 22 is formed of a polyimide in which the mole ratio [B/(A+B)]×100 (% by mole) of the number of moles of the repeating unit B to the total number of moles of the repeating unit A and the repeating unit B is 60% or more by mole, is satisfied. Second, because the occurrence of cracking after exposure to a high temperature and high humidity environment for extended periods can be reduced, the condition (2): in the scattered X-ray profile 50 of the insulating film 22 analyzed by X-ray diffractometry at a diffraction angle 2θ of 10 degrees or more and 41 degrees or less, the ratio of the area of the second region between the diffraction pattern profile 60 extracted from the scattered X-ray profile 50 and the base line B to the area of the first region between the scattered X-ray profile 50 and the base line B is 15% or less, is satisfied. Satisfying these two conditions can provide the insulated electric wire 2 including the insulating film 22 formed of the polyimide with high resistance to hygrothermal degradation.

### [Production of Insulated Electric Wire]

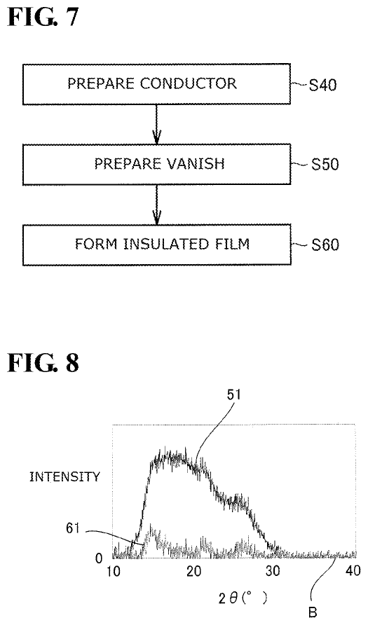

Next, the steps in a method for producing the insulated electric wire 2 according to the present embodiment are described below with reference to FIGS. 5 and 7. FIG. 7 is a flow chart of the steps in a process of producing the insulated electric wire 2. In the present embodiment, the steps S40 to S60 illustrated in FIG. 7 are performed.

### [Preparation of Conductor 12]

As illustrated in FIGS. 5 and 7, the linear conductor 12 is prepared (S40). More specifically, a unit wire is prepared, and the unit wire is subjected to processing, such as drawing (wire drawing), to prepare the conductor 12 with a desired diameter and shape. The unit wire is preferably formed of a metal with high electric conductivity and high mechanical strength. Examples of such a metal include copper, copper alloys, aluminum, aluminum alloys, nickel, silver, soft iron, steel, and stainless steel. The conductor 12 of the insulated electric wire 2 may be formed of a linearly formed material of one of these metals or a multilayer structure produced by covering such a linear material with another metal, for example, a nickel-coated copper wire, a silver-coated copper wire, a copper-coated aluminum wire, or a copper-coated steel wire.

The average cross-sectional area of the conductor 12 of the insulated electric wire preferably has a lower limit of 0.01 mm², more preferably 0.1 mm². The average cross-sectional area of the conductor 12 preferably has an upper limit of 10 mm², more preferably 5 mm². When the conductor 12 has an average cross-sectional area smaller than the lower limit, the resistance may increase. On the other hand, when the conductor 12 has an average cross-sectional area larger than the upper limit, the insulating layer must be thickened to sufficiently decrease the dielectric constant, and the diameter of the insulated electric wire may be unnecessarily increased.

[Preparation of Varnish (Poly(amic acid) Solution)]

Next, a varnish containing a polyimide precursor poly(amic acid) (poly(amic acid) solution) is prepared (S50).

A polyimide precursor (poly(amic acid)), which is a raw material of the polyimide, is a prepolymer that forms the polyimide by imidization, and is a reaction product produced by polymerization between tetracarboxylic dianhydride PMDA and BPDA and a diamine ODA. Thus, the raw materials of the polyimide precursor are PMDA, BPDA, and ODA.

Tetracarboxylic dianhydride used as raw materials of the polyimide precursor are pyromellitic dianhydride (PMDA) and 3,3′,4,4′-biphenyltetracarboxylic dianhydride (BPDA). The ratio of BPDA to the tetracarboxylic dianhydride is 60% or more by mole. Preferably, the mole ratio is 62% or more by mole. The ratio of BPDA is preferably less than 80% by mole, more preferably less than 78% by mole. At a ratio of BPDA to the tetracarboxylic dianhydride in the above range, a BPDA-derived structure can be appropriately introduced into the main component polyimide of the insulating layer. Consequently, the appearance, bending workability, and resistance to hygrothermal degradation can be improved in a balanced manner.

The lower limit of the PMDA content per 100% by mole of the tetracarboxylic dianhydride used as raw materials of the polyimide precursor is preferably 5% by mole, more preferably 8% by mole. The upper limit of the PMDA content is 40% by mole. A PMDA content lower than the lower limit may result in insufficient heat resistance of the insulating layer. On the other hand, a PMDA content higher than the upper limit may result in insufficient introduction of a BPDA-derived structure into the main component polyimide of the insulating layer and may result in lower resistance to hygrothermal degradation of the insulating layer.

A diamine used as a raw material of the polyimide precursor is 4,4′-diaminodiphenyl ether (4,4′-oxydianiline (ODA)). ODA can be used to improve the tenacity of the insulating layer.

The weight-average molecular weight of the polyimide precursor preferably has a lower limit of 10,000, more preferably 15,000. The weight-average molecular weight preferably has an upper limit of 180,000, more preferably 130,000. The polyimide precursor with a weight-average molecular weight greater than or equal to the lower limit can form an extensible polyimide that can easily retain a constant molecular weight even after hydrolysis, and thereby can further improve the flexibility and resistance to hygrothermal degradation of the insulating layer. The polyimide precursor with a weight-average molecular weight smaller than or equal to the upper limit can suppress an extreme increase in the viscosity of a resin varnish for use in the production of the insulated electric wire and improve coating performance. Furthermore, the concentration of the polyimide precursor in the resin varnish can be easily increased while good coating performance is maintained. The term “weight-average molecular weight”, as used herein, refers to the value measured by gel permeation chromatography (GPC) according to HS-K7252-1: 2008 “Plastics-Determination of average molecular mass and molecular mass distribution of polymers using size-exclusion chromatography—Part 1: General principles”.

The polyimide precursor can be produced by a polymerization reaction between the tetracarboxylic dianhydride(s) and the diamine. For example, in the present embodiment, the polymerization reaction can be performed as described below. First, 100% by mole of the diamine ODA is dissolved in N-methyl-2-pyrrolidone (NMP). 95% by mole to 100% by mole of tetracarboxylic dianhydride composed of PMDA and BPDA at a predetermined ratio are then added and stirred in a nitrogen atmosphere. The reaction is then performed at 80° C. for 3 hours while stirring. After the reaction, the reaction solution is naturally cooled to room temperature. Thus, a varnish containing the polyimide precursor dissolved in N-methyl-2-pyrrolidone is prepared.

Although N-methyl-2-pyrrolidone (NMP) is used as an organic solvent in the embodiment, another aprotic polar organic solvent may also be used. Examples of the other aprotic polar organic solvent include N,N-dimethylformamide, N,N-dimethylacetamide, dimethyl sulfoxide, and γ-butyrolactone. These organic solvents may be used alone or in combination. The term “aprotic polar organic solvent”, as used herein, refers to a polar organic solvent that has no proton-release group.

Any amount of the organic solvent may be used, provided that PMDA, BPDA, and ODA can be uniformly dispersed. For example, the amount of the organic solvent to be used may be 100 parts or more by mass and 1,000 parts or less by mass per 100 parts by mass of PMDA, BPDA, and ODA in total.

The polymerization reaction conditions may be appropriately determined depending on the raw materials to be used or the like. For example, the reaction temperature may be 10° C. or more and 100° C. or less, and the reaction time may be 0.5 hours or more and 24 hours or less.

The mole ratio (tetracarboxylic dianhydride/diamine) of the tetracarboxylic dianhydride (PMDA and BPDA) to the diamine (ODA) used in the polymerization is preferably closer to 100/100 in order to efficiently promote the polymerization reaction. For example, the mole ratio may be 95/105 or more and 105/95 or less.

The varnish may contain another component or additive agent in addition to the above components within the bounds of not reducing the above effects. For example, the varnish may contain various additive agents, such as a pigment, a dye, an inorganic or organic filler, a curing accelerator, a lubricant, an adhesion improver, and a stabilizer, and another compound, such as a reactive low-molecular-weight compound.

A polyimide in which the ratio of the area of the second region between the diffraction pattern profile 60 extracted from the scattered X-ray profile 50 and the base line B to the area of the first region between the scattered X-ray profile 50 and the base line B is 15% or less in the scattered X-ray profile 50 of the insulating film 22 analyzed by X-ray diffractometry at a diffraction angle 2θ of 10 degrees or more and 41 degrees or less can be prepared by adjusting the blend ratio of the raw materials PMDA, BPDA, and ODA for the polyimide or by adjusting the molecular weight of poly(amic acid) or the degree of polymerization of the polyimide. The molecular regularity peak ratio can be controlled by adjusting the polymerization conditions, the temperature conditions, the addition method, or the addition of a nucleating agent or a crystallization retardant.

### [Formation of Insulating Film 22]

The conductor 12 is then covered with the insulating film 22 (S60). The insulating film 22 is formed to cover the periphery of the linear conductor 12. First, the varnish prepared in S50 is applied to the surface of the conductor 12 to form a coating film on the surface of the conductor 12. The conductor 12 on which the coating film is formed is then passed through a furnace heated to, for example, 350° C. to 500° C. for 20 seconds to 2 minutes, for example, for 30 seconds, for heating. Heating the coating film promotes imidization by dehydration of poly(amic acid), hardens the coating film, and forms the insulating film 22 formed of the polyimide on the conductor 12. The coating and heating cycle is performed, for example, 10 times to increase the thickness of the insulating film 22. Consequently, the insulating film 22 can have a desired thickness (for example, 35 μm). In this manner, the insulated electric wire 2 is produced that includes the conductor 12 and the insulating film 22 of the polyimide disposed to cover the periphery of the conductor 12.

### EXAMPLES

The invention according to the present disclosure is more specifically described in the following examples. However, the present disclosure is not limited to these examples. In the examples, the insulated electric wires 1 and 2 were produced by the following methods.

Among the components used in the examples, components represented by the abbreviations have the following formal names.

(Acid Anhydride Components)

PMDA: pyromellitic dianhydride

BPDA: 3,3′,4,4′-biphenyltetracarboxylic dianhydride

(Diamine component)

ODA: 4,4′-diaminodiphenyl ether (4,4′-oxydianiline, 4,4′-ODA)

### Examples Related to First Embodiment

### Example 1

### [Preparation of Resin Varnish]

100% by mole of ODA was dissolved in an organic solvent N-methyl-2-pyrrolidone. PMIDA and BPDA were then added to the solution at a mole ratio listed in Tables 1 and 2. The solution was stirred in a nitrogen atmosphere. A reaction was then performed at 80° C. for 3 hours while stirring. The solution was then cooled to room temperature. Thus, a resin varnish containing a polyimide precursor dissolved in N-methyl-2-pyrrolidone was prepared. The concentration of the polyimide precursor in the resin varnish was 30% by mass.

### [Production of First Insulated Electric Wire 1]

A round wire with an average diameter of 1 mm composed mainly of copper (a conducting wire in which the conductor 10 had a circular cross section perpendicular to the longitudinal direction) was prepared as the conductor 10. The resin varnish prepared as described above was applied to the periphery of the conductor 10. The conductor 10 to which the resin varnish was applied was heated in a furnace at a heating temperature of 400° C. for a heating time of 30 seconds. The coating step and heating step were performed 10 times. Thus, a first insulated electric wire 1 was prepared that included the conductor 10 and the insulating film 20 with an average thickness of 35 μm formed on the periphery of the conductor 10.

### [Production of Second Insulated Electric Wire 1]

A rectangular conducting wire composed mainly of copper (a conducting wire in which the conductor 10 had a tetragonal cross section 1 mm in height and 4 mm in width perpendicular to the longitudinal direction) was prepared as the conductor 10. The resin varnish prepared as described above was applied to the periphery of the conductor 10. The conductor 10 to which the resin varnish was applied was heated in a furnace at a heating temperature of 400° C. for a heating time of 30 seconds. The coating step and heating step were performed 10 times. Thus, a second insulated electric wire 1 was prepared that included the conductor 10 and the insulating film 20 with an average thickness of 35 μm formed on the periphery of the conductor 10.

### [Tensile Test]

### (Preparation of Tensile Test Sample)

The first insulated electric wire 1 was elongated to 107% of the original length (a separation elongation of 7%) with a tensile tester (“AG-IS” manufactured by Shimadzu Corporation) at a crosshead speed of 10 mm/min. The elongated first insulated electric wire 1 was removed from the tensile tester. A gap was form at the interface between the conductor 10 and the insulating film 20 by electrolysis in saline to separate the conductor 10 from the insulating film 20. The separated insulating film 20 was used as a first sample of a tensile test sample. The electrolysis in saline was performed under the following conditions: saline concentration: 5%, electrode: positive electrode=carbon electrode, negative electrode=the conductor 10, voltage=20 V.

The second insulated electric wire 1 was elongated to 140% of the original length (a separation elongation of 40%) with the tensile tester (“AG-IS” manufactured by Shimadzu Corporation) at a crosshead speed of 10 mm/min. The elongated second insulated electric wire 1 was removed from the tensile tester. A gap was form at the interface between the conductor 10 and the insulating film 20 by electrolysis in saline to separate the conductor 10 from the insulating film 20. The separated insulating film 20 was used as a second sample of a tensile test sample.

### (Tensile Test)

The first sample or the second sample was tested with the tensile tester (“AG-IS” manufactured by Shimadzu Corporation) at a crosshead speed of 10 mm/min and at a gauge length of 20 mm. For the first sample, on the basis of a stress-strain curve measured in the tensile test, the ratio M₆₀/M₁₀ of tensile stress M₆₀ at an elongation percentage of 60% to tensile stress M₁₀ at an elongation percentage of 10% was determined. Table 1 shows the results. For the second sample, on the basis of a stress-strain curve measured in the tensile test, the ratio M₃₀/M₁₀ of tensile stress M₃₀ at an elongation percentage of 30% to tensile stress M₁₀ at an elongation percentage of 10% was determined. Table 2 shows the results.

### [Evaluation of Insulated Electric Wire 1]

### [Evaluation of Resistance to Hygrothermal Degradation]

The resistance to hygrothermal degradation of the insulated electric wire 1 was evaluated in a water tightness test at 120° C. for 500 hours according to the following procedures under the following conditions. The test was performed through the following procedures. A 10%-elongated insulated electric wire 1 was placed in an autoclave airtight container containing water and was held in a thermostat at 120° C. for 500 hours. Subsequently, the insulating film 20 was visually inspected for cracking, and the breakdown voltage was determined. Tables 1 and 2 show the results.

TABLE 1

| | | Experiment No. | | | | | | | | | |
|---|---|---|---|---|---|---|---|---|---|---|---|
| | | 1 | 2 | 3 | 4 | 5 | 6 | 7^{※1} | 8^{※3} | 9 | 10 |
| Acid (mol) | PMDA | 60 | 45 | 40 | 35 | 30 | 25 | 25 | 25 | 20 | 0 |
| | BPDA | 40 | 55 | 60 | 65 | 70 | 75 | 75 | 75 | 80 | 100 |
| Diamine (mol) | ODA | 100 | 100 | 100 | 100 | 100 | 100 | 100 | 100 | 100 | 100 |

| | | | | | | | | | | |
|---|---|---|---|---|---|---|---|---|---|---|
| Mole ratio [B/(A + | 40 | 55 | 60 | 65 | 70 | 75 | 75 | 75 | 80 | 100 |
| B)] × 100 (mol %) | | | | | | | | | | |
| Ratio M₆₀/M₁₀ | 1.34 | 1.37 | 1.38 | 1.39 | 1.41 | 1.28 | 1.19 | 1.15 | 1.19 | 0.00 (※3) |
| Presence of crack after | Yes | Yes | No | No | No | No | Yes | Yes | Yes | Yes |
| water tightness test | | | | | | | | | | |
| Breakdown voltage after | 0 | 0 | 5 | 5 | 5 | 5 | 0 | 0 | 0 | 0 |
| water tightness test [kV] | | | | | | | | | | |

^{※1}The heating time in the baking furnace was shortened to 44%.
^{※3}Water was added in the preparation of the resin varnish and was removed under reduced pressure after the reaction. The amount of water added was 47 parts by mass per 100 parts by mass of PMDA, BPDA, and ODA in total.
(※3) Not measured due to breakage at an elongation percentage of less than 60%.

TABLE 2

| | | Experiment No. | | | | | | | |
|---|---|---|---|---|---|---|---|---|---|
| | | 11 | 12 | 13 | 14 | 15 | 16 | 17 | 18 |
| Acid (mol) | PMDA | 60 | 45 | 40 | 35 | 30 | 25 | 20 | 0 |
| | BPDA | 40 | 55 | 60 | 65 | 70 | 75 | 80 | 100 |
| Diamine (mol) | ODA | 100 | 100 | 100 | 100 | 100 | 100 | 100 | 100 |

| | | | | | | | | |
|---|---|---|---|---|---|---|---|---|
| Mole ratio [B/(A + | 40 | 55 | 60 | 65 | 70 | 75 | 80 | 100 |
| B)] × 100 (mol %) | | | | | | | | |
| Ratio M₃₀/M₁₀ | 1.38 | 1.32 | 1.32 | 1.34 | 1.41 | 1.28 | 1.15 | 0.00 (※4) |
| Presence of crack after | Yes | Yes | No | No | No | No | Yes | Yes |
| water tightness test | | | | | | | | |
| Breakdown voltage after | 0 | 0 | 5 | 5 | 5 | 5 | 0 | 0 |
| water tightness test [kV] | | | | | | | | |

(※4) Not measured due to breakage at an elongation percentage of less than 30%.

In Table 1, experiments No. 3 to No. 6 show the results of examples, and experiments No. 1 and No. 2 and experiments No. 7 to No. 10 show the results of comparative examples. In Table 2, experiments No. 13 to No. 16 show the results of examples, and experiments No. 11 and No. 12 and experiments No. 17 and No. 18 show the results of comparative examples.

Table 1 shows that the experiments No. 3 to No. 6, which satisfy the conditions that the mole ratio [B/(A+B)]×100 (% by mole) of the number of moles of the repeating unit B to the total number of moles of the repeating unit A and the repeating unit B is more than 55% by mole and that the ratio M₆₀/M₁₀ of tensile stress M₆₀ at an elongation percentage of 60% to tensile stress M₁₀ at an elongation percentage of 10% in the first sample is 1.2 or more, had no fissure or crack in the insulating film 20 even after the water tightness test. Thus, the insulated electric wires 1 including such an insulating film 20 have high resistance to hygrothermal degradation and suffer less degradation even after long-term use.

In contrast, the experiments No. 1 and No. 2, in which the mole ratio [B/(A+B)]×100 (% by mole) is 55% or less by mole, and the experiments No. 7 to No. 10, in which the ratio M₆₀/M₁₀ is less than 1.2, had a crack after the water tightness test. Thus, the insulated electric wires 1 including the insulating films 20 composed of the materials according to these comparative examples are likely to have a crack during long-term use.

In Table 1, in the experiment No. 6, which is an example, and the experiments No. 7 and No. 8, which are comparative examples, the blend ratio of PMDA to BPDA is 25:75 (mass ratio). However, in a tensile test performed at a crosshead speed of 10 mm/min on the first sample of the insulating film with a separation elongation of 7%, the ratio M₆₀/M₁₀ of tensile stress M₆₀ at an elongation percentage of 60% to tensile stress M₁₀ at an elongation percentage of 10% is 1.2 or more in the experiment No. 6 and less than 1.2 in the experiments No. 7 and No. 8. Consequently, no crack was observed in the experiment No. 6 after the water tightness test, whereas a crack was observed in the experiments No. 7 and No. 8. Even with the same blend, a difference in production conditions may result in a different stress-strain curve, and the ratio M₆₀/M₁₀ is 1.2 or more in one case and is not 1.2 or more in another case. A comparison between the experiment No. 6 and the experiments No. 7 or No. 8 showed that the insulating film 20 with fewer cracks can be formed by controlling the production conditions such that the ratio M₆₀/M₁₀ is 1.2 or more.

The breakdown voltage was measured after the water tightness test. The experiments No. 3 to No. 6 had a breakdown voltage of 5 kV and maintained their insulating properties, whereas the experiments No. 1 and No. 2 and the experiments No. 7 to No. 9 had a breakdown voltage of 0 kV and lost their insulating properties. Thus, the insulated electric wires 1 in the experiments No. 3 to No. 6 maintain their insulating properties even after long-term use.

A comparison between the experiment No. 6 and the experiment No. 7 showed that even with the same composition of the insulating film 20, the insulating film 20 deteriorates during long-term use unless the ratio M₆₀/M₁₀ is 1.2 or more. This result showed that the ease of degradation of the insulating film 20 does not depend on the composition of the insulating film 20 alone.

Table 2 shows that the experiments No. 13 to No. 16, which satisfy the conditions that the mole ratio [B/(A+B)]×100 (% by mole) of the number of moles of the repeating unit B to the total number of moles of the repeating unit A and the repeating unit B is more than 55% by mole and that the ratio M₃₀/M₁₀ of tensile stress M₃₀ at an elongation percentage of 30% to tensile stress M₁₀ at an elongation percentage of 10% in the second sample is 1.2 or more, had no fissure or crack in the insulating film 20 even after the water tightness test. Thus, the insulated electric wires 1 including such an insulating film 20 have high resistance to hygrothermal degradation and suffer less degradation even after long-term use.

In contrast, the experiments No. 11 and No. 12, in which the mole ratio [B/(A+B)]×100 (% by mole) is 55% or less by mole, and the experiments No. 17 and No. 18, in which the ratio M₃₀/M₁₀ is less than 1.2, had a crack after the water tightness test. Thus, the insulated electric wires 1 including the insulating films 20 composed of the materials according to these comparative examples are likely to have a crack during long-term use.

The breakdown voltage was measured after the water tightness test. The experiments No. 13 to No. 16 had a breakdown voltage of 5 kV and had insulating properties, whereas the experiments No. 11 and No. 12 and the experiments No. 17 and No. 18 had a breakdown voltage of 0 kV and lost their insulating properties. Thus, the insulated electric wires 1 in the experiments No. 13 to No. 16 maintain their insulating properties even after long-term use.

These results show that the insulated electric wire 1 including the insulating film 20 with high resistance to hygrothermal degradation can be provided if the insulating film 20 satisfies the condition that the insulating film 20 is formed of (1) a polyimide in which the mole ratio [B/(A+B)]×100 (% by mole) of the number of moles of the repeating unit B to the total number of moles of the repeating unit A and the repeating unit B is more than 55% by mole, and satisfies at least one of the condition (2): in a tensile test performed at a crosshead speed of 10 mm/min on the first sample of the insulating film 20 with a separation elongation of 7%, the ratio M₆₀/M₁₀ of tensile stress M₆₀ at an elongation percentage of 60% to tensile stress M₁₀ at an elongation percentage of 10% is 1.2 or more, and the condition (3): in a tensile test performed at 10 mm/min on the second sample of the insulating film 20 with a separation elongation of 40%, the ratio M₃₀/M₁₀ of tensile stress M₃₀ at an elongation percentage of 30% to tensile stress M₁₀ at an elongation percentage of 10% is 1.2 or more.

### Examples Related to Second Embodiment

### Example 2-1

### [Preparation of Varnish]

100% by mole of ODA was dissolved in an organic solvent N-methyl-2-pyrrolidone. PMDA and BPDA were then added to the solution at PMDA:BPDA=40:60 (mole ratio). The solution was stirred in a nitrogen atmosphere. A reaction was then performed at 80° C. for 3 hours while stirring. The solution was then cooled to room temperature. Thus, a resin varnish containing a polyimide precursor dissolved in N-methyl-2-pyrrolidone was prepared. The concentration of the polyimide precursor in the resin varnish was 30% by mass.

### [Preparation of Conductor 12 and Production of Insulated Electric Wire 2]

A rectangular conducting wire composed mainly of copper (a conducting wire in which the conductor 12 had a tetragonal cross section 1 mm in height and 4 mm in width perpendicular to the longitudinal direction) was prepared as the conductor 12. The resin varnish prepared as described above was applied to the periphery of the conductor 12. The conductor 12 to which the resin varnish was applied was heated in a furnace at a heating temperature of 400° C. for a heating time of 30 seconds. The coating step and heating step were performed 10 times. Thus, an insulated electric wire 2 was prepared that included the conductor 12 and the insulating film 22 with an average thickness of 35 μm formed on the periphery of the conductor 12.

Next, a measurement was performed with an X-ray diffractometer (X'Pert, manufactured by Spectris) under the following conditions: X-ray used: Cu-Ka line focus, excitation conditions: 45 kV, 40 mA, incident optical system: mirror, slit: ½, mask: 10 mm, sample stage: open Eulerian cradle, light-receiving optical system: flat collimator 0.27, scanning method: 0-20 scan, measurement range: 20=5 to 80, step width: 0.03 degrees, elapsed time 1 second.

The insulating film 22 of the insulated electric wire 2 was subjected to structural analysis by X-ray diffractometry to determine the molecular regularity peak ratio. FIG. 8 shows a scattered X-ray profile 51 of the insulating film 22 and a diffraction pattern profile 61 extracted from the scattered X-ray profile 51. In Example 2-1, the ratio of the area of a second region between the diffraction pattern profile 61 and a base line B to the area of a first region between the scattered X-ray profile 51 and the base line B (molecular regularity peak ratio) was 13.6%. The resistance to hygrothermal degradation of the insulating film 22 of the insulated electric wire 2 prepared in Example 2-1 was evaluated. Table 3 shows the results.

### Example 2-2

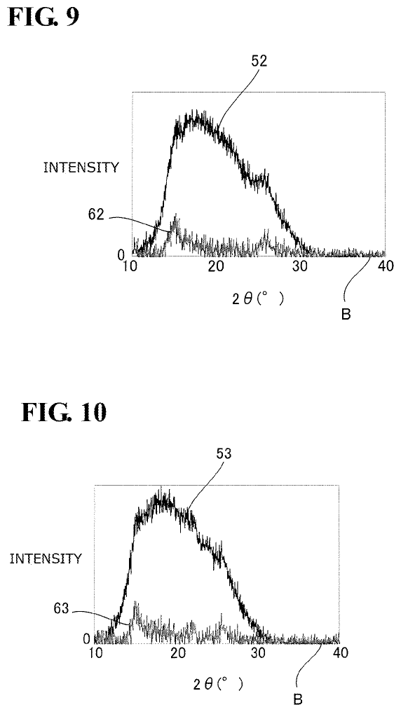

An insulated electric wire 2 was produced in the same manner as in Example 2-1 except that PMDA and BPDA were added at PMDA:BPDA=35:65 (mole ratio), and the molecular regularity peak ratio was adjusted to be 12.6%. The molecular regularity peak ratio was determined in the structural analysis of the insulating film 22 by X-ray diffractometry in the same manner as in Example 2-1. FIG. 9 shows a scattered X-ray profile 52 of the insulating film 22 and a diffraction pattern profile 62 extracted from the scattered X-ray profile 52. The resistance to hygrothermal degradation of the insulating film 22 of the insulated electric wire 2 prepared in Example 2-2 was evaluated. Table 3 shows the results.

### Example 2-3

An insulated electric wire 2 was produced in the same manner as in Example 2-1 except that PMDA and BPDA were added at PMDA:BPDA=25:75 (mole ratio), and the molecular regularity peak ratio was adjusted to be 12.3%. The molecular regularity peak ratio was determined in the structural analysis of the insulating film 22 by X-ray diffractometry in the same manner as in Example 2-1. FIG. 10 shows a scattered X-ray profile 53 of the insulating film 22 and a diffraction pattern profile 63 extracted from the scattered X-ray profile 53. The resistance to hygrothermal degradation of the insulating film 22 of the insulated electric wire 2 prepared in Example 2-3 was evaluated. Table 3 shows the results.

### Comparative Example 2-1

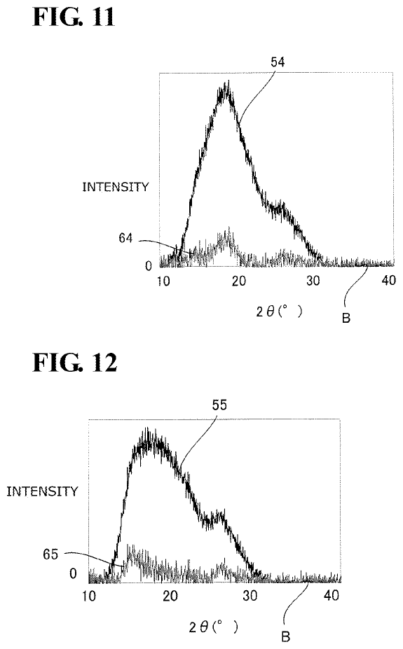

An insulated electric wire 2 was produced in the same manner as in Example 2-1 except that PMDA and BPDA were added at PMDA:BPDA=100:0 (mole ratio), and the molecular regularity peak ratio was adjusted to be 12.2%. The molecular regularity peak ratio was determined in the structural analysis of the insulating film 22 by X-ray diffractometry in the same manner as in Example 2-1. FIG. 11 shows a scattered X-ray profile 54 of the insulating film 22 and a diffraction pattern profile 64 extracted from the scattered X-ray profile 54. The resistance to hygrothermal degradation of the insulating film 22 of the insulated electric wire 2 prepared in Comparative Example 2-1 was evaluated. Table 3 shows the results.

### Comparative Example 2-2

An insulated electric wire 2 was produced in the same manner as in Example 2-1 except that PMDA and BPDA were added at PMDA:BPDA=60:40 (mole ratio), and the molecular regularity peak ratio was adjusted to be 13.4%. The molecular regularity peak ratio was determined in the structural analysis of the insulating film 22 by X-ray diffractometry in the same manner as in Example 2-1. FIG. 12 shows a scattered X-ray profile 55 of the insulating film 22 and a diffraction pattern profile 65 extracted from the scattered X-ray profile 55. The resistance to hygrothermal degradation of the insulating film 22 of the insulated electric wire 2 prepared in Comparative Example 2-2 was evaluated. Table 1 shows the results.

### Comparative Example 2-3

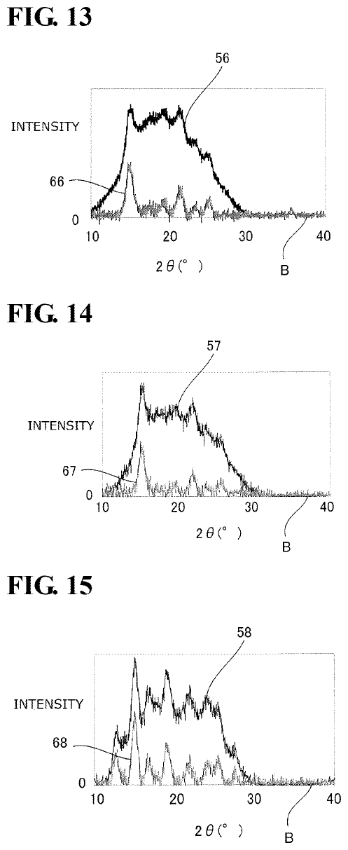

An insulated electric wire 2 was produced in the same manner as in Example 2-1 except that PMDA and BPDA were added at PMDA:BPDA=25:75 (mole ratio), and the molecular regularity peak ratio was adjusted to be 15.3%. The molecular regularity peak ratio was determined in the structural analysis of the insulating film 22 by X-ray diffractometry in the same manner as in Example 2-1. FIG. 13 shows a scattered X-ray profile 56 of the insulating film 22 and a diffraction pattern profile 66 extracted from the scattered X-ray profile 56. The resistance to hygrothermal degradation of the insulating film 22 of the insulated electric wire 2 prepared in Comparative Example 2-3 was evaluated. Table 3 shows the results.

### Comparative Example 2-4

An insulated electric wire 2 was produced in the same manner as in Example 2-1 except that PMDA and BPDA were added at PMDA:BPDA=20:80 (mole ratio), and the molecular regularity peak ratio was adjusted to be 16.5%. The molecular regularity peak ratio was determined in the structural analysis of the insulating film 22 by X-ray diffractometry in the same manner as in Example 2-1. FIG. 14 shows a scattered X-ray profile 57 of the insulating film 22 and a diffraction pattern profile 67 extracted from the scattered X-ray profile 57. The resistance to hygrothermal degradation of the insulating film 22 of the insulated electric wire 2 prepared in Comparative Example 2-4 was evaluated. Table 3 shows the results.

### Comparative Example 2-5

An insulated electric wire 2 was produced in the same manner as in Example 2-1 except that only BPDA was used as tetracarboxylic dianhydride, and the molecular regularity peak ratio was adjusted to be 23.3%. The molecular regularity peak ratio was determined in the structural analysis of the insulating film 22 by X-ray diffractometry in the same manner as in Example 2-1. FIG. 15 shows a scattered X-ray profile 58 of the insulating film 22 and a diffraction pattern profile 68 extracted from the scattered X-ray profile 58. The resistance to hygrothermal degradation of the insulating film 22 of the insulated electric wire 2 prepared in Comparative Example 2-5 was evaluated. Table 3 shows the results.

TABLE 3

| | | Experiment No. | | | | | | | |
|---|---|---|---|---|---|---|---|---|---|
| | | 21 | 22 | 23 | 24 | 25 | 26 | 27 | 28 |
| Acid (mol) | PMDA | 100 | 60 | 40 | 35 | 25 | 25 | 20 | 0 |
| | BPDA | 0 | 40 | 60 | 65 | 75 | 75 | 80 | 100 |
| Diamine (mol) | ODA | 100 | 100 | 100 | 100 | 100 | 100 | 100 | 100 |

| | | | | | | | | |
|---|---|---|---|---|---|---|---|---|
| Mole ratio [B/(A + | 0 | 40 | 60 | 65 | 75 | 75 | 80 | 100 |
| B)] × 100 (mol %) | | | | | | | | |
| Molecular regularity | 12.2 | 13.4 | 13.6 | 12.6 | 12.3 | 15.3 | 16.5 | 23.3 |
| peak ratio (%) | | | | | | | | |
| Presence of crack after | Yes | Yes | No | No | No | Yes | Yes | Yes |
| water tightness test | | | | | | | | |
| Breakdown voltage after | 0 | 0 | 5 | 5 | 5 | 0 | 0 | 0 |
| water tightness test [kV] | | | | | | | | |
| (resistance to hygrothermal | | | | | | | | |
| degradation) | | | | | | | | |

In Table 3, experiment No. 21 corresponds to Comparative Example 2-1. Experiment No. 22 corresponds to Comparative Example 2-2. Experiment No. 23 corresponds to Example 2-1. Experiment No. 24 corresponds to Example 2-2. Experiment No. 25 corresponds to Example 2-3. Experiment No. 26 corresponds to Comparative Example 2-3. Experiment No. 27 corresponds to Comparative Example 2-4. Experiment No. 28 corresponds to Comparative Example 2-5.

The results in Table 3 show that a crack appeared in the water tightness test when the ratio of the amount of the repeating unit B to the total amount of PMDA-derived repeating unit A and BPDA-derived repeating unit B is less than 60% by mole. Furthermore, the breakdown voltage was 0 V, and the insulating properties were lost (Comparative Examples 2-1 and 2-2 (experiments No. 21 and No. 22)). Thus, it was confirmed that when the ratio was less than 60% by mole, the resistance to hygrothermal degradation was low.

If the ratio of the amount of the repeating unit B to the total amount of PMDA-derived repeating unit A and BPDA-derived repeating unit B is 60% or more by mole, a molecular regularity peak ratio of 15% or less results in no cracking and the maintenance of insulating properties (Examples 2-1 to 2-3 (experiments No. 23 to No. 25)). This shows that the insulated electric wires 2 according to the examples have high resistance to hygrothermal degradation. Thus, the insulated electric wires 2 according to Examples 2-1 to 2-3 maintain their insulating properties even after long-term use.

On the other hand, even when the ratio of the amount of the repeating unit B to the total amount of PMDA-derived repeating unit A and BPDA-derived repeating unit B is 60% or more by mole, a crack appeared in the water tightness test when the molecular regularity peak ratio is more than 15%. Furthermore, the breakdown voltage was 0 V, and the insulating properties were lost (Comparative Examples 2-3 to 2-5 (experiments No. 26 to No. 28)). Thus, it was confirmed that even when the ratio is 60% or more by mole, a molecular regularity peak ratio of more than 15% results in low resistance to hygrothermal degradation.

Focusing on Example 2-3 (experiment No. 25) and Comparative Example 2-3 (experiment No. 26), both Example 2-3 and Comparative Example 2-3 have a blend ratio of PMDA to BPDA=25:75 (mass ratio). However, the insulating film 22 is formed such that the molecular regularity peak ratio is 15% or less in Example 2-3, whereas the insulating film 22 is formed such that the molecular regularity peak ratio is more than 15% in Comparative Example 2-3. Consequently, Example 2-3 (experiment No. 25) had no crack after the water tightness test and maintained the insulating properties, but Comparative Example 2-3 (experiment No. 26) had a crack and lost its insulating properties. Thus, even with the same blend, the molecular regularity peak ratio depends on the production conditions or the like. This comparison shows that controlling the production conditions can reduce cracks and maintain the insulating properties of the insulating film 22 thus formed.

The results in the examples and comparative examples show that satisfying the following two conditions can provide the insulated electric wire 2 including the insulating film 22 of the polyimide with high resistance to hygrothermal degradation. More specifically, it is clearly shown that satisfying the two conditions: (1) the insulating film 22 is formed of a polyimide in which the mole ratio [B/(A+B)]×100 (% by mole) of the number of moles of the repeating unit B to the total number of moles of the repeating unit A and the repeating unit B is 60% or more by mole, and (2) in a scattered X-ray profile of the insulating film 22 analyzed by X-ray diffractometry at a diffraction angle 2θ of 10 degrees or more and 41 degrees or less, the ratio of the area of a second region between a diffraction pattern profile extracted from the scattered X-ray profile and a base line B to the area of a first region between the scattered X-ray profile and the base line B is 15% or less, can provide the insulated electric wire 2 including the insulating film 22 of the polyimide with high resistance to hygrothermal degradation

It is to be understood that the embodiments and examples disclosed herein are illustrated by way of example and not by way of limitation in all respects. The scope of the present invention is defined by the appended claims rather than by the embodiments described above. All modifications that fall within the scope of the claims and the equivalents thereof are therefore intended to be embraced by the claims.

### REFERENCE SIGNS LIST

1 insulated electric wire
10 conductor
12 conductor
20 insulating film
22 insulating film
30 stress-strain curve
32 stress-strain curve
40 stress-strain curve
50 scattered X-ray profile
51 scattered X-ray profile
52 scattered X-ray profile
53 scattered X-ray profile
54 scattered X-ray profile
55 scattered X-ray profile
56 scattered X-ray profile
57 scattered X-ray profile
58 scattered X-ray profile
60 diffraction pattern profile
61 diffraction pattern profile
62 diffraction pattern profile
63 diffraction pattern profile
64 diffraction pattern profile
65 diffraction pattern profile
66 diffraction pattern profile
67 diffraction pattern profile
68 diffraction pattern profile

1. An insulated electric wire comprising:
a conductor that has a linear shape; and
an insulating film that is formed to cover the periphery of the conductor,
wherein the insulating film is formed of a polyimide that has a molecular structure including a repeating unit A represented by the following formula (1) and 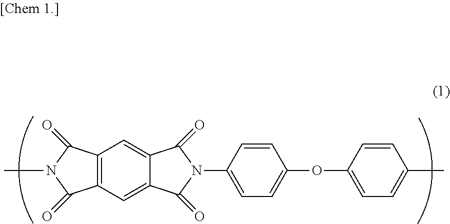
a repeating unit B represented by the following formula (2), 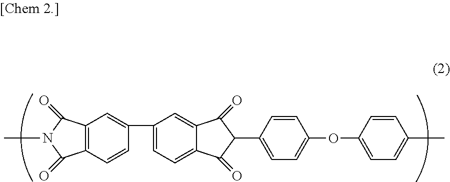
the mole ratio [B/(A+B)]×100 (% by mole) of the number of moles of the repeating unit B to the total number of moles of the repeating unit A and the repeating unit B is more than 55% by mole, and
in a tensile test performed at a crosshead speed of 10 mm/min on a first sample of the insulating film with a separation elongation of 7%, the ratio M₆₀/M₁₀ of tensile stress M₆₀ at an elongation percentage of 60% to tensile stress M₁₀ at an elongation percentage of 10% is 1.2 or more.

2. An insulated electric wire comprising:
a conductor that has a linear shape; and
an insulating film that is formed to cover the periphery of the conductor,
wherein the insulating film is formed of a polyimide that has a molecular structure including a repeating unit A represented by the following formula (1) and 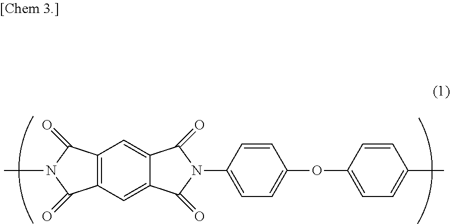
a repeating unit B represented by the following formula (2), 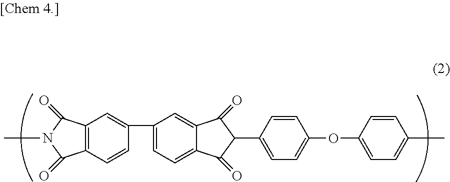
the mole ratio [B/(A+B)]×100 (% by mole) of the number of moles of the repeating unit B to the total number of moles of the repeating unit A and the repeating unit B is more than 55% by mole, and
in a tensile test performed at 10 mm/min on a second sample of the insulating film with a separation elongation of 40%, the ratio M₃₀/M₁₀ of tensile stress M₃₀ at an elongation percentage of 30% to tensile stress M₁₀ at an elongation percentage of 10% is 1.2 or more.

3. The insulated electric wire according to claim 1, wherein
the mole ratio [B/(A+B)]×100 (% by mole) is less than 80% by mole.

4. An insulated electric wire comprising:
a linear conductor; and
an insulating film that is disposed to cover the periphery of the conductor,
wherein the insulating film is formed of a polyimide that has a molecular structure including a repeating unit A represented by the following formula (1) and 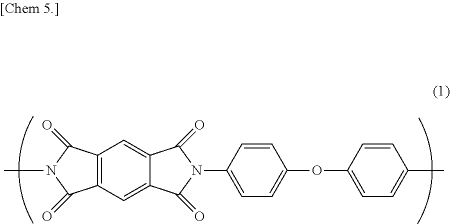
a repeating unit B represented by the following formula (2), 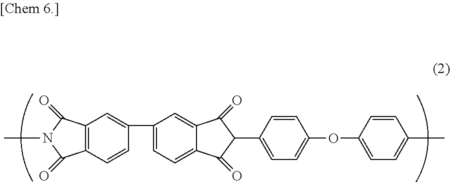
the ratio of the amount of the repeating unit B to the total amount of the repeating unit A and the repeating unit B is 60% or more by mole, and
in a scattered X-ray profile of the insulating film analyzed by X-ray diffractometry at a diffraction angle 2θ of 10 degrees or more and 41 degrees or less, the ratio of the area of a second region between a diffraction pattern profile extracted from the scattered X-ray profile and a base line to the area of a first region between the scattered X-ray profile and the base line is 15% or less.

5. The insulated electric wire according to claim 4, wherein
the ratio of the amount of the repeating unit B to the total amount of the repeating unit A and the repeating unit B is less than 80% by mole.

6. The insulated electric wire according to claim 2, wherein
the mole ratio [B/(A+B)]×100 (% by mole) is less than 80% by mole.
